(19) United States
(12) Patent Application Publication
(10) Pub. No.: US 2012/0132575 A1
(43) Pub. Date: May 31, 2012

(54) FOAM WATER TREATMENT SYSTEM

(75) Inventors: Roy W. Kuennen, Caledonia, MI (US); Kenneth E. Conrad, Ada, MI (US); Audrey Conrad, Rockford, MI (US); David W. Baarman, Fennville, MI (US)

(73) Assignee: Access Business Group International LLC, Ada, MI (US)

(21) Appl. No.: 13/306,303

(22) Filed: Nov. 29, 2011

Related U.S. Application Data
(60) Provisional application No. 61/417,742, filed on Nov. 29, 2010.
(60) Provisional application No. 61/418,228, filed on Nov. 30, 2010.

(51) Int. Cl. B01D 39/16; C02F 3/02; B01D 29/50

(52) U.S. Cl. 210/151

(57) ABSTRACT

A foam filter is provided that may form a radial flow or a stacked flow filter. In the radial flow configuration, the foam may be wrapped around an inner support core. The inner support core may define holes to allow the water to enter the support core and exit the filter. More than one foam layer may be used, and a single sheet of foam wrapped in a spiral may form a multi-layer configuration. A non-permeable flexible layer may be positioned between adjacent foam layers to facilitate flow through the filter. In the stacked flow configuration, multiple foam layers may be used and water can flow successively or simultaneously through the foam layers. Functional layers may be added to provide other filtration functions.

### BACKGROUND OF THE INVENTION

The present disclosure relates to water treatment systems, and in particular to gravity feed water treatment systems.

### BACKGROUND OF THE INVENTION

As the world's population increases, the demand for water also increases. Indeed, in some parts of the world where the local population is growing at a much higher rate than average, the availability of safe drinking water is lower than average. Some of this situation can be attributed to geography, whether from an arid climate or simply the lack of fresh surface water suitable for drinking. Additionally, many wellheads are running dry due to the lowering of underground aquifers, resulting in new wells being drilled to deeper depths, in an attempt to find water. In many cases, high costs prohibit these operations. Further, in many locales where water is very scarce, the population is unable to purchase water for consumption due to their low income levels and the fact that municipally treated water is unavailable. Examples of such settings may include rural villages in under-developed countries, emergency relief sites following natural disasters, or camp settings, to name a few.

Gravity feed water treatment systems are used globally to help low income populations provide safe water for their families for drinking and cooking. One known gravity feed water treatment system uses a bio-sand water filter to treat water. These systems have a biological layer that is formed from natural processes that destroys unwanted microorganisms and organics in water. The bio-sand filters commonly used in residential and small village settings tend to be large and heavy. Some contain as much as 100 pounds of sand and gravel.

Some advancements in bio-sand filters have been made over the years. For example, some bio-sand filters have adjusted the depth and particle size composition in order to control the face velocity at the top of the exposed sand layer. In effect, one of the reasons for the large mass of sand and gravel in the deeper layers is to establish and control back-pressure so that the face velocity through the sand bed is kept within the recommended range. Although these advancements have made the gravity feed systems more effective in some circumstances, installation can be more complicated because often times the flow rate must be adjusted during installation to ensure that the system is working properly.

Some believe that the two main disadvantages of bio-sand water treatment systems are the weight of the sand and specific particle size needed for the sand. The manufacturing and transportation of the sand has been a major obstacle in the global implementation of bio-sand filters. There are water treatment systems that utilize concrete and plastic alternatives. However, these systems have their own disadvantages. Concrete is even heavier than sand, and may be more scarce than sand in remote areas where it is needed.

### SUMMARY OF THE INVENTION

A gravity feed water treatment system is provided that includes a foam filter having a cellular structure that supports the colonization of biological biomes and supports these structures mechanically. The construction of the foam is reticulated at an initial thickness and densified to 0.300 inches. The reticulated foam can support a biological layer on and/or within the foam. The foam is porous, light weight, and easy to install. Reticulated foam water treatment systems can be configured in either a cartridge configuration or a stack configuration.

There are a variety of foam filter configurations that include a reticulated foam filter element. The foam filter may have a collection reservoir for collecting water that has been filtered by the foam filter element and a filter outlet in fluid communication with the collection reservoir for dispensing water from the filter. The foam filter element may be densified to increase a number of strands per unit volume within the foam filter element. The foam filter element may also include nutrients to attract biological organisms.

There are a variety of foam filter cartridge configurations. In one embodiment, foam is wrapped around an inner support core and end caps are bonded to seal the cartridge. The support core can increase the structural integrity of the filter cartridge. The filter cartridge may include one layer or multiple layers of foam, each with the same or different pore sizes and/or the same or different thicknesses. Multiple layers of foam can increase the quality of the water treatment.

There are also a variety of foam filter stack configurations. In one embodiment, multiple layers of foam are stacked and water flows through multiple stages either simultaneously or in succession. Water flowing through multiple stages simultaneously can increase the speed of the water treatment and water flowing through multiple stages in succession can increase the quality of the water treatment.

In foam filter cartridge and foam filter stack configurations, additional functional layers of various materials may be included to increase the overall water treatment. For example, functional layers may be included to address various water contaminants, such as hardness, arsenic, or fluoride.

Foam filtration alleviates many of the issues with bio-sand filters, notably the weight and installation issues. The weight of a foam filter water treatment system is a fraction of the weight of a bio-sand water treatment system. The foam filter systems are also easily installed by the end user without the need for a trained installer.

These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and may be practiced or carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIGS. 1A-1B show a single layer radial flow foam filter cartridge.

FIGS. 2A-2C show a multi layer radial flow foam filter cartridge.

FIGS. 3A-3C show a multi layer radial flow foam filter cartridge with a functional layer.

FIGS. 4A-4C show a rolled foam filter cartridge.

FIG. 5A shows a sheet of foam with flow channels.

FIGS. 5B-5D show various configurations of a rolled foam filter cartridge with flow channels.

FIG. 6 shows a flat foam sheet.

FIG. 7 shows a multi-layer foam filter stack with an influent/effluent tube.

FIG. 8A shows a non permeable support with water collection ribs attached and supported by the collection tube

FIG. 8B shows how this support allows water effluent collection of the multi-layer foam filter stack of FIG. 7.

FIG. 9 shows a multi-layer foam filter stack.

FIG. 10 shows a multi-cell foam filter.

FIG. 11 shows a dual tank treatment system with a foam filter stack.

FIG. 12 shows a dual tank treatment system with a foam filter cartridge.

FIG. 13 shows a stacked dual tank treatment system with a foam filter cartridge.

### DESCRIPTION OF THE CURRENT EMBODIMENTS

The water treatment systems of the present disclosure are configurable to a variety of situations. The various components can be used singly or in various combinations to treat water for consumption or other uses. It is important to note that the configurations detailed below are exemplary and not exhaustive.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized.

Using foam as a filter is lighter weight than the sand and concrete constructions described above. However, foam water treatment systems may experience a variety of problems. For example, a large foam thickness may be required to achieve a desired level of filtration or a desired flow rate. Further, the foam in some configurations may become anaerobic, which decreases the treatment capability of the foam. Even further, the bacteria and biological organisms that help water treatment are often prevented from penetrating the foam. Still further, some foam configurations have a tendency to clog.

Foam can be classified depending on its pore or cell structure as either open-cell or closed-cell. Open-cell foam is also known as reticulated foam and includes interconnected pores that form a network or a foam matrix. The structure of the foam matrix is maintained by individual strands of foam that preserve the interconnection between the foam pores. In contrast, closed-cell foam has separate, isolated pores that are not interconnected.

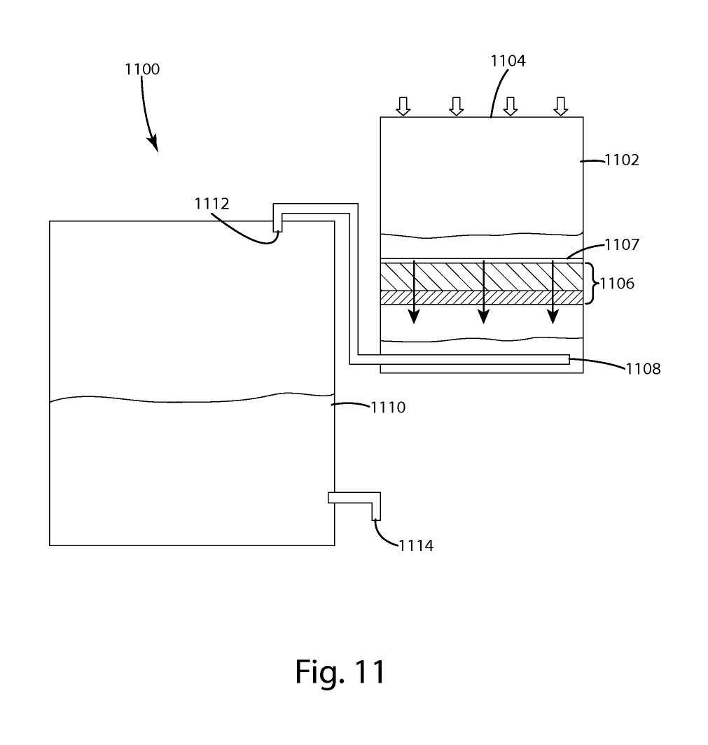

The reticulated foam filter of the present invention can be implemented in a variety of different water treatment systems. For example, a disc foam filter 1106 may be implemented in a water treatment and storage system 1100 as shown in FIG. 11. The depicted water treatment and storage system 1100 includes a treatment tank 1102 and storage tank 1110. The treatment tank 1102 includes an inlet 1104, a disc foam filter 1106, and an outlet 1108. In the illustrated embodiment, the disc foam filter 1106 is sealed to the side wall of the treatment tank 1102 so that water poured into the inlet 1104 passes through the biological layer 1107 formed on the disc foam filter 1106, thereby treating the water. The biological layer 1107 formed on the foam can provide a high degree of treatment for reducing bacteria, viruses and protozoan when operated in a batch process with a controlled flow rate. It should be noted that this biological layer can be formed in two weeks and can be accelerated if needed with some of the processes discussed below. In one system embodiment a prefilter is included that performs the same level of filtration as this system but is disposed of or dissolves after two weeks when the biological layer is formed. In some embodiments, the prefilters do not last very long but aid in letting the system get started filtering without the two week delay.

In the current embodiments, the reticulated foam may be a medical grade polyether 2-1000 foam of a specific pore size and pore density. For example, the medical grade foam may have a pore density greater than approximately 70 pores per square inch, optionally between approximately 80 and 120 pores per square inch and further optionally approximately 100 pores per square inch. Multiplying the 100 pores per square inch by 2 felt yields 200 pores per inch. The foam may also be densified. For example, the foam can be manufactured with an original density, and then compressed to between two and three times the original foam density. If the compression is carried out in a single direction, it can preserve the number of pores per square inch on the face of the foam, while increasing the number of structural strands per unit volume. Increasing the number of strands per unit volume may provide more locations for bacteria and organisms to reside and be retained in the foam filter, which may increase the effectiveness of the foam filter in treating water. The thickness of the foam filter may be made quite small while maintaining the number or pores per square inch of face area, maintaining an appropriate back pressure and maintaining an adequate level of filtration. For example, the thickness of the reticulated foam filter may be less than approximately 1 inch thick, optionally between approximately 0.2 and 0.6 inches thick, and further optionally approximately 0.3 inches thick. The small thickness and the reticulation of the foam may allow air to penetrate the foam and may prevent the foam filter from becoming anaerobic, which would otherwise decrease the effectiveness of the foam filter.

In the current embodiments and as further described below, a restriction orifice may be positioned at the outlet of the foam filter or at the outlet of the water treatment system to control the flow rate through the water treatment system. The restriction orifice may be any suitable restrictor that decreases volume flow rate at the outlet, including a washer-shaped plate that decreases the size of the outlet of the foam filter or decreases the size of the outlet of the water treatment system. Optionally, the flow rate may be between approximately 0.5 milliliters (ml) and 1.5 ml per minute per square centimeter (cm) of foam surface area, further optionally between approximately 0.8 ml and 1.2 ml per minute per square cm of foam surface area and even further optionally approximately 1 ml per minute per square cm of foam surface area.

One or more of the embodiments may decrease clogging of the foam filter and allow the filter to shed off dead bacteria, which may allow the biological layer to grow and absorb nutrients such as oxygen and organics. One or more of the embodiments may also allow the foam filter to absorb and feed on harmful organisms when water is flowing through the filter. For example, the bacteria and organisms that penetrate the foam as described above may feed on the harmful organisms as they pass through the filter. One or more of the embodiments may also allow the organisms in the filter to release more proteases instead of developing the biological layer. One or more of these advantages may be provided by the network of the foam matrices, including the density of the cells and the strands created by the reticulation and densification of the foam.

In the illustrated embodiment, the disc foam filter 1106 includes two discs of foam. In alternative embodiments, a single layer of foam or additional layers of foam may be utilized. Various embodiments of the disc foam filter will be described in more detail below. In the illustrated embodiment, the outlet 1108 of the treatment tank is in fluid communication with an inlet 1112 of a storage tank 1110. The storage tank can be used to collect the treated water until it is ready to be consumed. The storage tank 1110 includes an outlet 1114, which could include a spigot, or essentially any other dispensing system. In use, untreated water is poured into the treatment tank 1102, passes through the biological layer 1107 and disc foam filter 1106, and exits the treatment tank 1102 through the outlet 1108 into the treated water storage tank 1110.

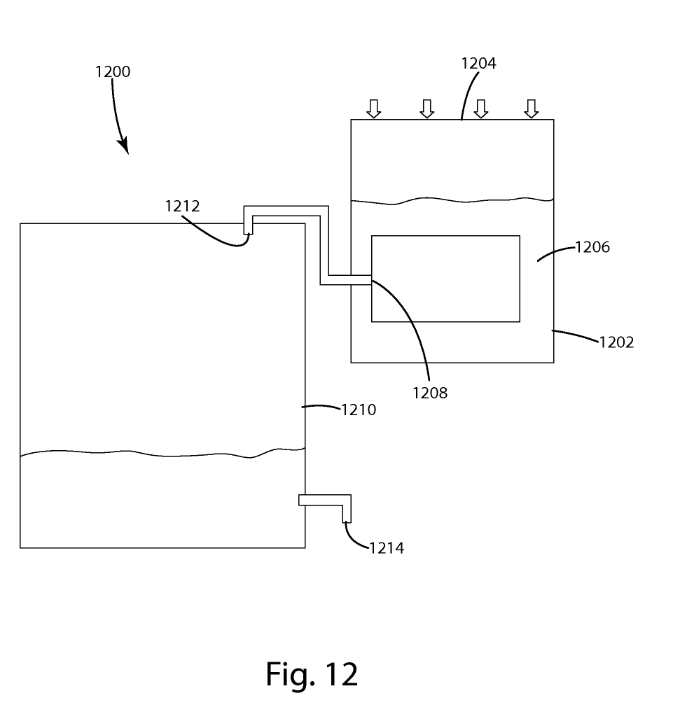

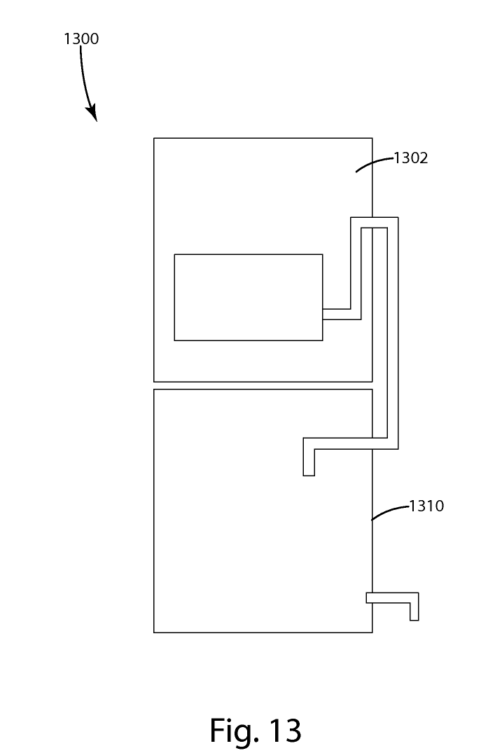

FIG. 12 illustrates another embodiment of a water treatment and storage system 1200. The primary difference between the water treatment system in FIG. 11 and the one shown in FIG. 12 is that the embodiment depicted in FIG. 12 includes a foam filter 1206 cartridge instead of a disc foam filter. Various embodiments of the cartridge foam filter will be described in more detail below. In use, untreated water is poured into the inlet 1204 of the treatment tank 1202, water surrounds and passes through the biological layer formed on the radial foam filter cartridge 1206, and exits the treatment tank 1202 via the outlet 1208 in the foam filter cartridge The outlet 1108 of the treatment tank is in fluid communication with an inlet 1212 of a storage tank 1210. The storage tank 1210 includes an outlet 1214, which could include a spigot, or essentially any other dispensing system. FIG. 13 illustrates an alternative embodiment of a water treatment and storage system 1300 where the treatment tank 1302 and the storage tank 1310 are stacked on top of one another.

FIGS. 11-13 illustrate a few examples of water treatment systems utilizing foam filter elements. It should be noted that a variety of additional components may be included in alternative embodiments of these water treatment systems, including but not limited to a pre-filter media, a layer of sand, a flocculation tank, a chlorinator and dechlorinator, and a flow rate control. For example, in order to control flow rate and face velocity a restriction orifice may be placed anywhere along one of the water outlets. In another example, a shallow layer of sand may be added to the top of the foam to promote better formation of the biological layer. In yet another example, a pre-filter media may be used to cover one or more foam layers in either a foam filter stack or a foam filter cartridge in order to allow easier cleaning and reduce clogging of the foam pores. In yet another example, the foam filter may include a flow controller so the flow rate is correct upon installation based on the container size and head pressure. In still another example, two radial filters may be used in parallel to increase the surface area of foam for treating water and facilitate easier stacking of buckets containing the filters. For example, the two radial filters may create a lower profile that may allow for more use of the container. The lower profile may create more space to allow for easier stacking of the water treatment containers.

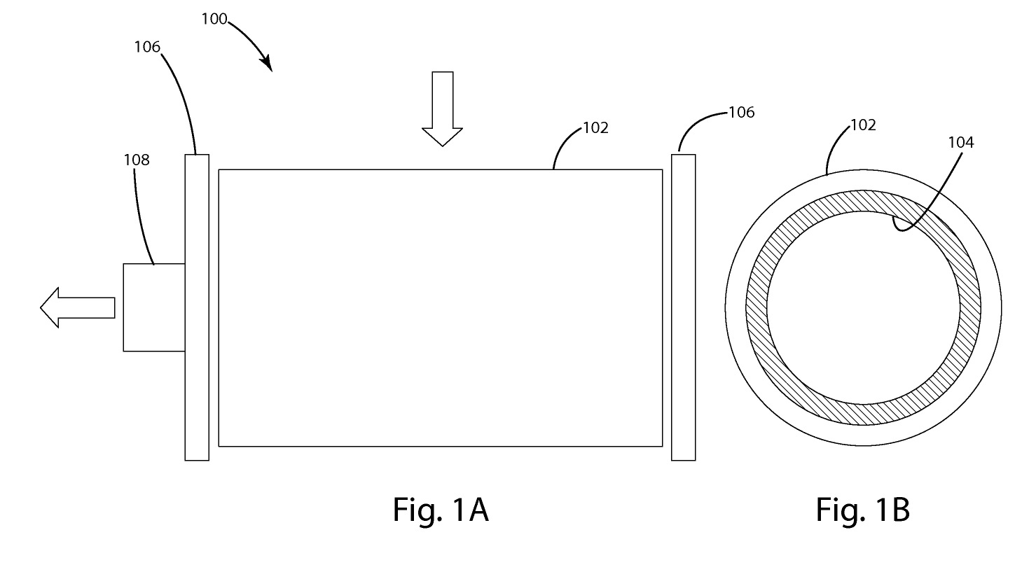

There are a variety of different embodiments of cartridge foam filters. One embodiment of a foam filter cartridge 100 is depicted in FIGS. 1A-1B. The foam filter cartridge includes a foam layer 102, an inner support core 104, and a pair of end caps 106. In the current embodiment, the foam layer 102 is wrapped around the inner support core 104 and the ends of the foam layer are bonded to the end caps with a suitable adhesive, such as hot melt. In alternative embodiments, the foam filter cartridge 100 may be assembled using essentially any technique that seals the end caps to the foam layer 102 or support core 104. The support core 104 can help to provide the foam filter cartridge with rigidity and can increase the structural integrity of the foam filter cartridge. In some embodiments, the support core 104 may be removed. The support core can be made of plastic or any other material that does not hinder the water treatment process.

FIG. 1A depicts an assembled foam filter cartridge 100 and shows the flow path of water through the filter. Water enters radially through the foam 102 being treated by a biological layer that forms on the foam. As described above, in this or in any embodiment in this application, biological organisms may penetrate the foam to treat water as it is flowing through the foam in addition to or instead of forming a surface biological layer. Once water permeates the foam it can flow into the center of the support core via holes in the support core. The number, size, and positioning of the holes in the support core can vary depending on the desired flow rate. From the center of the support core 104, water can flow axially to the outlet 108 located in one of the end caps 106. As noted above, a restriction orifice may be positioned at the outlet 108 to control the flow through the foam filter. Also as noted, an output flow restrictor may be added to any of the embodiments. The diameter of the support core 104 can also be used to assist in controlling the flow rate to the outlet. In the current embodiment, the diameter of the support core is larger than the diameter of the outlet in the end cap. In alternative constructions, the support core diameter may match or be less than the diameter of the outlet in the end cap. In other alternative embodiments, instead of flowing through the center of the support core, the support core may be non-permeable and water may flow along the exterior surface or along exterior channels. In a further alternative construction, the outlets of two radial foam filters may be connected to form a common outlet. This may increase the surface area of the foam for treating the water.

FIG. 1B illustrates an end view with the end caps removed. The relative diameters of the support core and the foam layer in the illustrated embodiment can be seen. It should be understood that in alternative embodiments, the diameters of the foam layer and the support core could vary relative to one another.

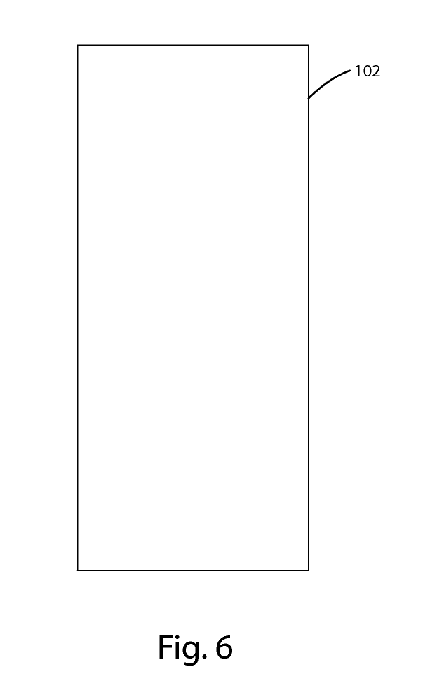

FIG. 6 depicts a sheet of foam that can be rolled into a cylinder and capped to form a radial flow filter element, such as the one shown in FIG. 1. In one embodiment, constructing a radial flow foam cartridge includes the steps of providing a sheet of foam, providing a plastic inner support core that has holes to allow flow, surrounding the support core with a continuous foam layer, providing two end caps, one with an outlet and one closed, and sealing the end caps to the foam. The sealing can be accomplished by use of a hot melt glue or other adhesive. The outlet hole in the end cap may have an orifice reducer fitted to control flow rate to not more than 0.8 liters per minute or to some other desired flow rate. In one embodiment, the length of the foam is approximately 10 inches, the thickness is approximately 0.3 inches with an outer diameter of approximately 4.2 inches. In the current embodiment, the foam is a polyether sulphone (medical grade) with 100 pores per inch. Polyurethane foam is stable for multiple years and will not be consumed by the microbes. Further, it is available in formulations that pass NSF for water contact. In alternative embodiments, different types of foam may be used with different amounts of pores.

In the current embodiment, the characteristics of the various components of the radial flow filter element produce a flow rate and resultant outer surface area that maintain a face velocity of approximately 1 cm/minute. In alternative embodiments, the characteristics of the various components of the radial flow filter element may vary to produce a different flow rate, face velocity, or other desired water treatment system characteristic. For example, in alternative embodiments, other foamed or porous materials or structures may replace the polymeric foam described above. For example, glass, metal, or other matrixes made by fusing small beads of a substance may be used. One exemplary embodiment includes porex sintered polyethylene, which also may work as a support for bio-formation.

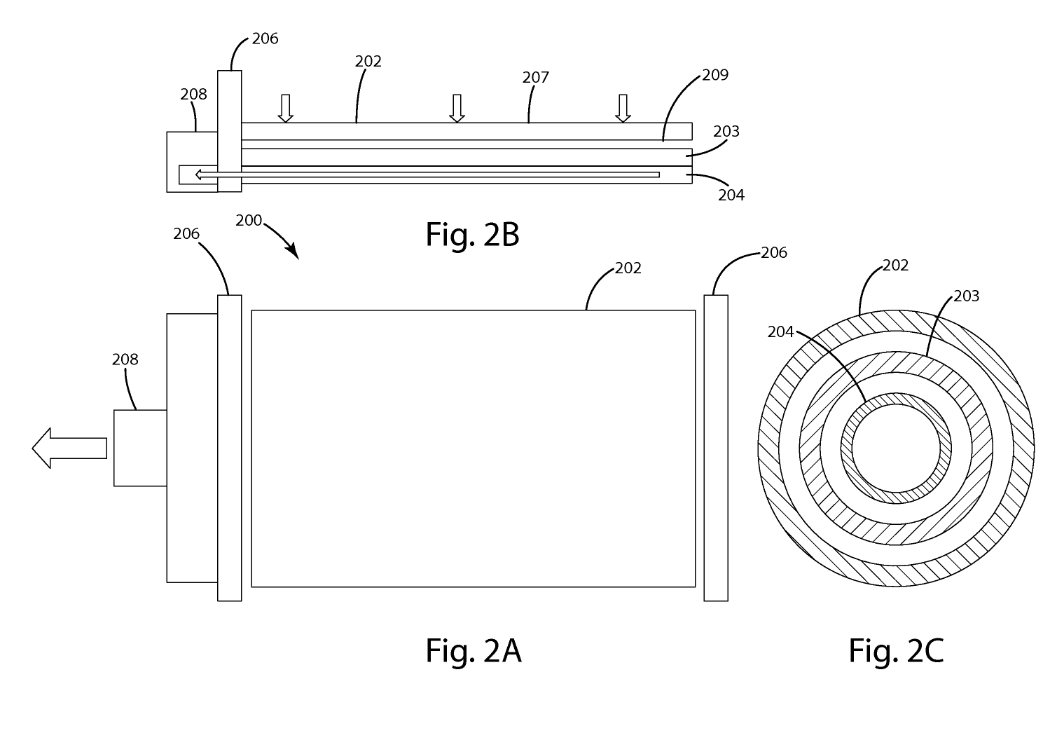

Performance of the foam filter cartridge can be enhanced in some embodiments by including multiple layers of foam. This can be accomplished in a variety of different ways. A few exemplary embodiments of multiple layer foam filter cartridges are illustrated in FIGS. 2-5.

One embodiment of a foam filter cartridge 200 with multiple foam layers is depicted in FIGS. 2A-2C. The foam filter cartridge 200 includes a first foam layer 202, a second foam layer 203, an inner support core 204, and a pair of end caps 206. In the current embodiment, the first foam layer 202 surrounds the second foam layer 203, and both foam layers 202, 203 surround the inner support core 204. In the depicted embodiment, the ends of the foam layers are bonded to the end caps 206 with a suitable adhesive, such as hot melt. In alternative embodiments, the foam filter cartridge 200 may be assembled using essentially any technique that seals the end caps to one or more of the foam layers 202, 203 and/or to the support core 204. In the depicted embodiment, the support core 204 helps to provide the foam filter cartridge 200 with rigidity and increases the structural integrity of the foam filter cartridge 200. In some embodiments, the support core 204 may be removed.

FIG. 2A depicts an assembled foam filter cartridge 200 with multiple layers of foam. FIG. 2B is a partial sectional view of the foam filter cartridge of FIG. 2A and shows an exemplary flow path of water through the filter. Water enters radially through the first foam layer 202 being treated by the biological layer 207 that forms on the first layer of foam. Water then passes through the second layer of foam 203. There may or may not be a second biological layer 209 that forms on the second layer of foam 203. Once the water passes through the second layer of foam 203 it can flow into the center of the support core 204 via holes in the support core. The number, size, and positioning of the holes in the support core can vary depending on the desired flow rate. From the center of the support core 204, water can flow axially to the outlet 208 located in one of the end caps 206. The diameter of the support core 204 can be used to assist in controlling the flow rate to the outlet 208.

Perhaps as best shown in FIG. 2C, the foam filter element 200 includes multiple foam layers 202, 203 and an inner support core 204. The proportions in FIG. 2C are exaggerated to illustrate the different layers. Providing multiple layers of foam allows different types of foam to be incorporated into a single cartridge. For example, the foam layers could have different pore sizes, different thicknesses of foam, or a variety of other different characteristics designed to enhance the performance of the water treatment system.

Although the biological layer is discussed throughout as forming on the surface of the foam, it should be understood that a biological layer may form throughout a portion of a foam layer, throughout an entire foam layer, or span over multiple foam layers. In some embodiments, it may be desirable to have the biological layer span multiple different types of foam. Further, multiple biological layers may form at different locations. In some embodiments, a biological layer may form wherever there is an air to foam interface. For example, in FIG. 2C, a biological layer may form not only on the surface of the first foam layer 202, but also on the interface between the first foam layer 202 and the second foam layer 203. Still further, nutrients may be retained during use within the pores or cells created during reticulation of the foam. Optionally, the nutrients may be intentionally positioned within the pores or cells in the foam during manufacture, to provide sustenance for biological organisms and attract the biological organisms to harbor in and reside in the foam. The biological organisms residing in the foam may then consume other harmful organisms in the water as the water is flowing through the foam. Any suitable nutrients may be used, including sugar, carbon-containing molecules, iron and other nutrients.

When assembled, in the illustrated embodiment the foam layers 202, 203 and the support core 204 are positioned adjacent to one another, perhaps as best shown in FIG. 2B. In alternative embodiments, space may purposely be provided between the first foam layer 202 and the second foam layer 203 and/or between the second foam layer 203 and the inner support core 204. An example of this type of configuration is depicted in FIG. 2C. The space can be created by placing permeable spacers between the layers, by utilizing the end caps to space the first foam layer 202, second foam layer 203, and the inner support core 204 apart, or by any other suitable technique.

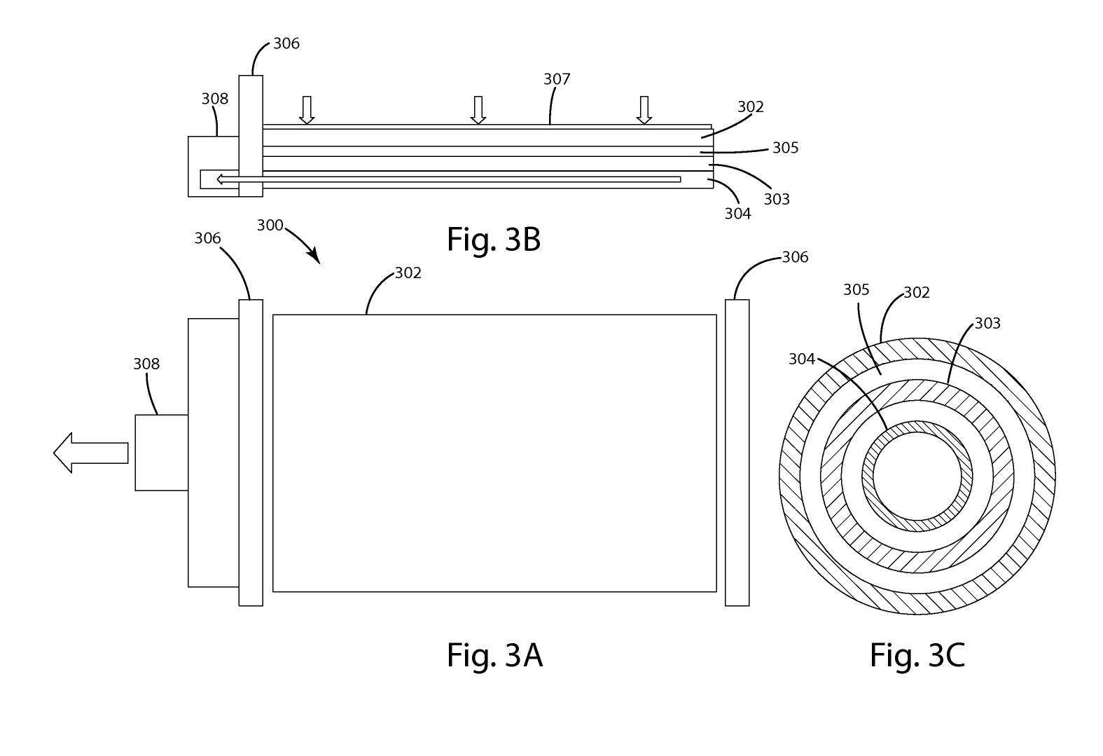

Another embodiment of a foam filter cartridge 300 with multiple foam layers is depicted in FIGS. 3A-3C. In this embodiment, one or more functional layers are included. A functional layer may be provided to address a specific water treatment issue. For example, the functional layer can be a non woven media with resin to address specific water contaminants, such as hardness, arsenic, or fluoride.

In FIGS. 3A-3C the foam filter cartridge 300 includes a first foam layer 302, a second foam layer 303, a functional layer 305, an inner support core 304, and a pair of end caps 306. In the current embodiment, the first foam layer 302 surrounds the functional layer 305, which surrounds the second foam layer 303, which surrounds the inner support core 304. In the depicted embodiment, the ends of the foam layers are bonded to the end caps 306 with a suitable adhesive, such as hot melt. In alternative embodiments, the foam filter cartridge 300 may be assembled using essentially any technique that seals the end caps to one or more of the foam layers 302, 303, the functional layer 305, and/or to the support core 304. In the depicted embodiment, the support core 304 helps to provide the foam filter cartridge 300 with rigidity and increases the structural integrity of the foam filter cartridge 300. In some embodiments, the support core 304 may be removed.

FIG. 3A depicts an assembled foam filter cartridge 300 with multiple layers of foam and a functional layer. FIG. 3B is a partial sectional view of the foam filter cartridge of FIG. 3A and shows an exemplary flow path of water through the filter. Water enters radially through the first foam layer 302 being treated by the biological layer 307 that forms on the first layer of foam. Water then passes through the functional layer 305. Then water passes through the second layer of foam 303. There may or may not be additional biological layers that form at the various interfaces in the filter or within the layers of the filter. Once the water passes through the second layer of foam 303 it can flow into the center of the support core 304 via holes in the support core. The number, size, and positioning of the holes in the support core can vary depending on the desired flow rate. From the center of the support core 304, water can flow axially to the outlet 308 located in one of the end caps 306. The diameter of the support core 304 can be used to assist in controlling the flow rate to the outlet 308.

Perhaps as best shown in FIG. 3C, the foam filter element 300 includes multiple foam layers 302, 303, a functional layer 305, and an inner support core 304. The proportions in FIG. 3C are exaggerated to illustrate the different layers. Providing multiple layers of foam allows different types of foam to be incorporated into a single cartridge. For example, the foam layers could have different pore sizes, different thicknesses of foam, or a variety of other different characteristics designed to enhance the performance of the water treatment system. As mentioned above, the functional layer can be provided for a variety of different functions. In some embodiments multiple functional layers may be provided to achieve the same purpose or different purposes. Further, the position of the functional layer can vary from application to application. In some embodiments, the functional layer may be the innermost layer, surrounding the inner core, in other embodiments the functional layer may be the outermost layer, surrounding the first foam layer.

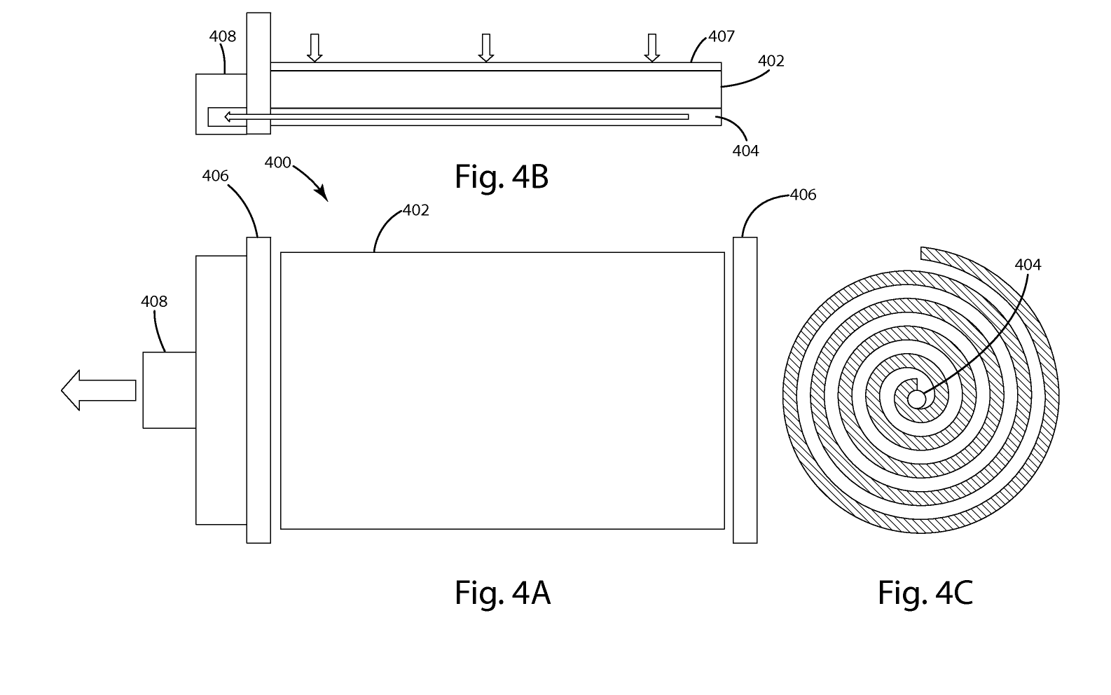

An embodiment of a foam filter cartridge 400 with multiple foam layers is depicted in FIGS. 4A-4C. In this embodiment, the multiple foam layers are formed by a single sheet of foam being rolled around a support core. The foam filter cartridge of the current embodiment provides additional contact with the water, which for some applications increases the performance of the filter.

In FIGS. 4A-4C the foam filter cartridge 400 includes a foam layer 402, an inner support core 404, and a pair of end caps 406. In the current embodiment, the foam layer 402 is rolled around the inner support core 404 in a spiral pattern. The ends of the foam layer 402 are bonded to the end caps 406 with a suitable adhesive, such as hot melt. In alternative embodiments, the foam filter cartridge 400 may be assembled using essentially any technique that seals the end caps 406 to the foam layer and/or to the support core 404. In the depicted embodiment, the support core 404 helps to provide the foam filter cartridge 400 with rigidity and increases the structural integrity of the foam filter cartridge 400. In some embodiments, the support core 404 may be removed.

FIG. 4A depicts an assembled foam filter cartridge 400 with a spiral foam layer.

FIG. 4B is a partial sectional view of the foam filter cartridge of FIG. 4A and shows an exemplary flow path of water through the filter. Water enters radially through the outer portion of the foam 402 being treated by the biological layer 407 that forms on the foam. Water then passes through the spiral layers in succession until reaching the inner support core 404. The number of layers the water passes through depends on the how many spirals were created when the foam was rolled around the inner support core. There may or may not be additional biological layers that form throughout the spiral foam 402. Once the water passes through the foam 402, it can flow into the center of the support core 404 via holes in the support core. The number, size, and positioning of the holes in the support core can vary depending on the desired flow rate. From the center of the support core 404, water can flow axially to the outlet 408 located in one of the end caps 406. The diameter of the support core 404 can be used to assist in controlling the flow rate to the outlet 408.

The spiral pattern of the foam filter element 400 can be seen in FIG. 4C, which depicts the foam filter 400 with the end caps 406 removed. The proportions in FIG. 4C are exaggerated to illustrate the spiral pattern of the foam. Providing a spiral of foam allows a single sheet of foam to incorporate multiple foam layers into a single cartridge. How tightly the foam is spiraled about the support core can change the performance characteristics of the water treatment system.

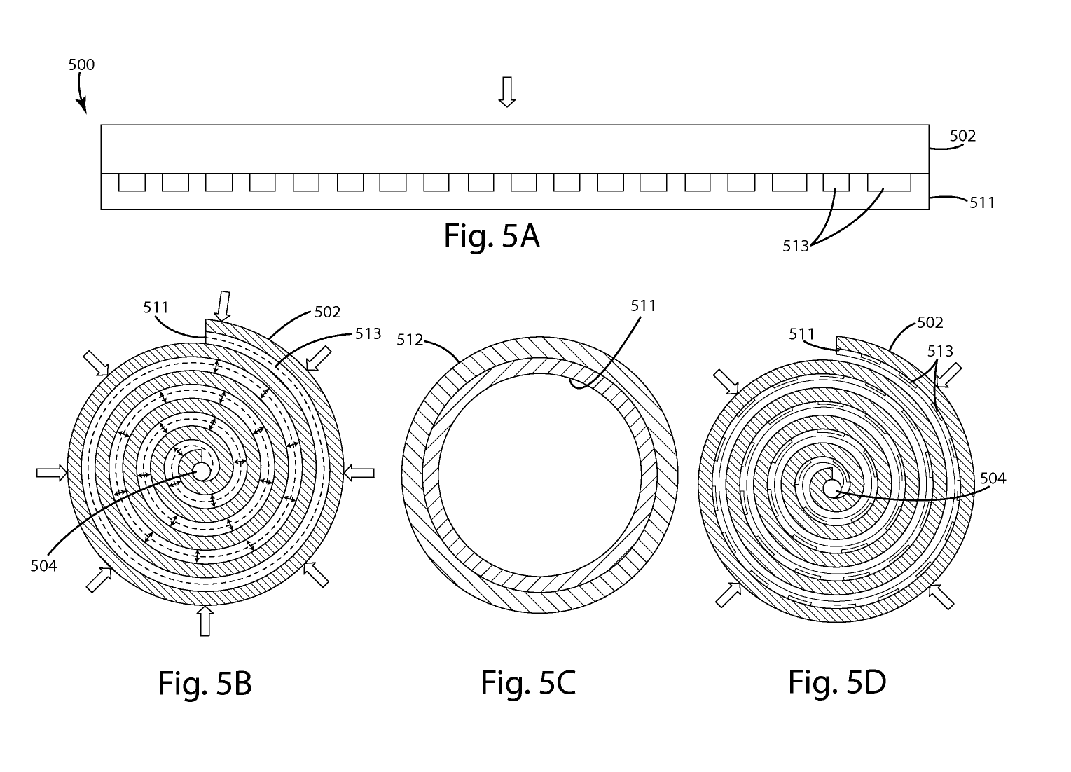

FIG. 5 illustrates a filter element 500, which includes a foam layer 502 and a flexible non-permeable layer 511 with a plurality of channels 513. The filter element can be used to create a number of different foam filter cartridges. An alternate embodiment allows for foam 502 on a top and bottom of non-permeable layer 511 with water transfer ribs 513 in the center.

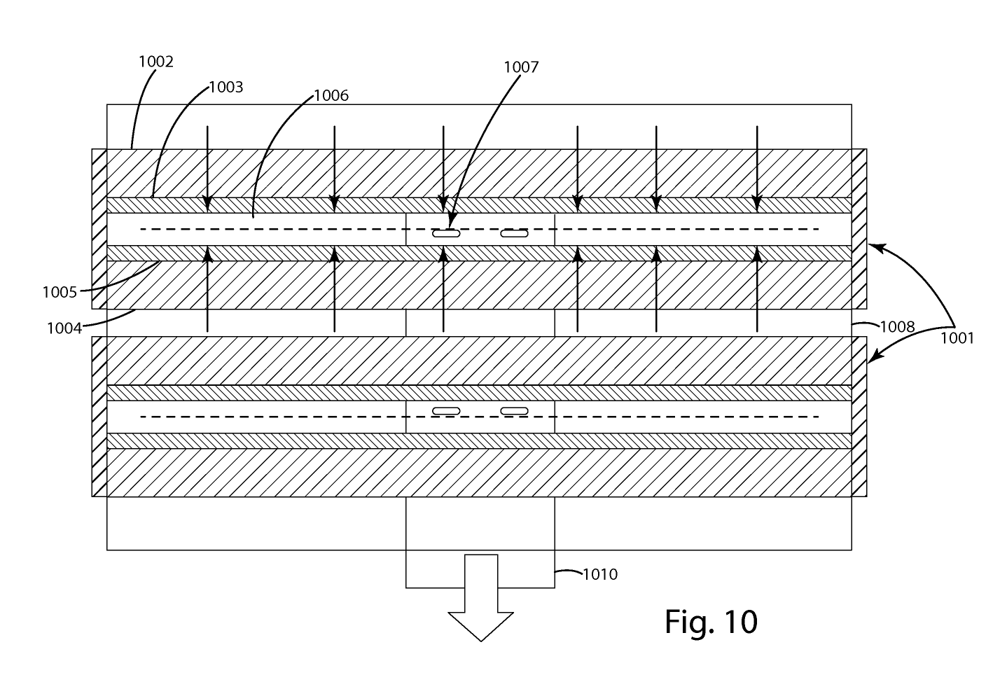

In the embodiment shown in FIG. 5B, the filter element 500 is rolled in a spiral pattern, similar to the FIG. 4 embodiment. The filter element 500 is rolled such that the channels 513 run parallel to the direction of the spiral. In the side view of the spiral filter element 500 shown in FIG. 5B, one of the parallel channels is shown in a dashed line. The arrows depict the general flow of water throughout the filter. Initially, water passes through the exterior foam layer 502 and then rides along the channel the entire length of the spiral. As water travels in the spiral it may pass back and forth between the foam layer 502 and the channels 513 in the non-permeable layer 511. Eventually, the water reaches the support core 504. Alternately the spiral foam can look more like FIG. 10 where we have two layers of foam inside and outside of a collector layer in the center of the foam layers doubling the respective surface area.

In the embodiment shown in FIG. 5D, the filter element 500 is also rolled in a spiral pattern, similar to the FIG. 4 embodiment. However, the filter element 500 is rolled such that the channels 513 run perpendicular to the direction of the spiral. In the side view of the spiral filter element 500 shown in FIG. 5D, the various perpendicular channels are shown. The arrows depict the general flow of water throughout the filter. Initially, water passes through the exterior foam layer 502 and then rides along the channels the entire length of the foam layer and empties into the outlet located in one of the end caps. In one embodiment, there is a gap between the foam and the non-permeable layer that allows water to travel through the spiral and reach the inner channels. In another embodiment, the non-permeable layer is replaced with a semi-permeable layer such that some water can reach the inner most channels. In yet another embodiment, the non-outlet end cap includes openings that allow water to reach the inner channels.

In the embodiment shown in FIG. 5C, the edges of the filter element 500 are edge welded to create a cylinder where the foam layer 502 forms the exterior of the cylinder and the non-permeable layer 511 forms the interior of the cylinder. End caps are bonded to the cylinder to create a foam filter cartridge. The channels can run perpendicular with the cylinder axis or parallel with the cylinder axis. In the parallel embodiment, each channel may include an exit hole in the bottom of the non-permeable layer 511 to provide access to the water outlet, for example in the center of a support core. In the perpendicular embodiment, each channel may be sealed on one end by an end cap, and flow along the cylinder axis into an outlet in the other end cap. In both embodiments, water enters the foam 502 radially and then moves along the channels 513 to eventually flow into an outlet located in an end cap.

The various foam filter cartridges are applicable to many different applications including point-of-use water treatment for drinking water, point-of-entry water treatment for residential houses, well water use, household water storage containers, municipal treatment plants, and rural settings to treat water as it is collected for storage and use.

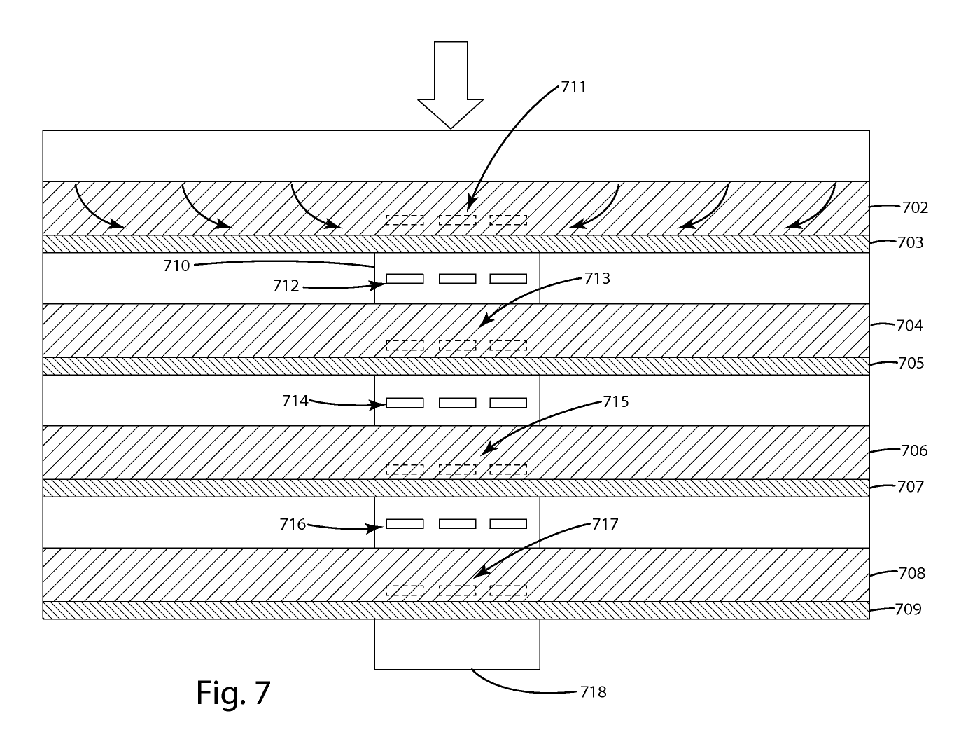

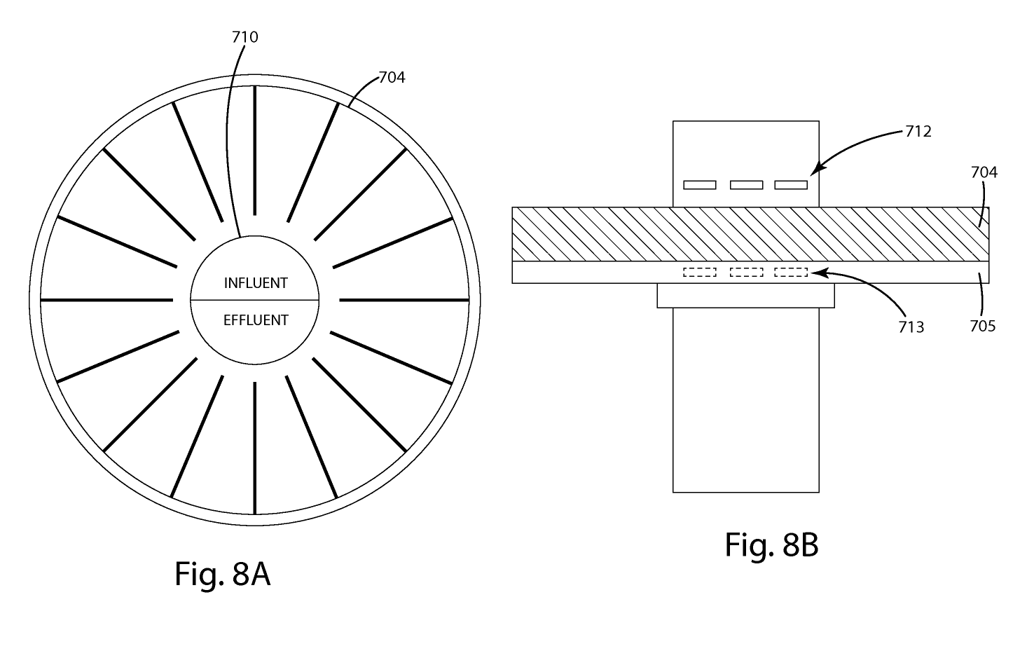

In addition to foam filter cartridges, there are a variety of different disc or stack foam filters that can be utilized in a variety of different water treatment systems. One embodiment of a foam filter stack 700 is depicted in FIGS. 7 and 8A-8B. The foam filter stack 700 treats water in stages. The top foam layer becomes the inlet to the second foam layer and this flow pattern repeats until the final stage. Each foam layer may include its own separate biological layer. Each stage may include other functional layers in addition to or instead of a biological layer in order to treat the water in a variety of different ways.

FIG. 7 illustrates the overall flow of water through one embodiment of a stack foam filter. Perhaps as best seen in FIG. 7, the foam filter stack 700 includes a plurality of foam layers 702, 704, 706, 708, a plurality of non-permeable layers 703, 705, 707, 709, and a pipe 710 with a plurality of pipe inlets 711, 713, 715, 717 and a plurality of pipe outlets 712, 714, 716.

FIG. 8A illustrates a representative sectional view of the stack foam filter. The view shows that the pipe 710 is sectioned such that water can only flow through the pipe by flowing through the various filter stages. In the current embodiment, the pipe 710 is divided into an influent side and an effluent side. Ribs may be used in the non permeable support to allow a gap under the filter to allow effluent water to flow freely to the collection tube. FIG. 8B illustrates a portion of the stack foam filter shown in FIG. 7 showing how the water flows from a pipe outlet 712 through a foam layer 704 into a channel in the non-permeable layer 705 and into the pipe inlet 713. A simple support disc allows easy assembly and support for the filter layer. It can set the proper spacing for the water to flow through the system properly.

Referring back to FIG. 7, in use, untreated water is poured on to the top of the first foam layer 702 and flows through the first foam layer 702 where it is directed by the non-permeable layer 703 into the pipe 710 via the inlet 711. Water then flows through the pipe 710 and reaches pipe outlet 712 where the water is forced to exit. The water passes through the foam layer 704 where it is directed by the non-permeable layer 705 into the pipe 710 via the pipe inlet 713. Water then flows through the pipe 710 and reaches pipe outlet 714 where the water is forced to exit. It should be noted that the non permeable layer may include a simple sealant or ultrasonic seal at points or along the ribs. Ribs or channels may also be formed in the bottom side of the filter and will also assist the flow of water allowing water to gather and flow along the non-permeable layer to the collection tube. Additional open foam layers may be used or other water collection media may be used to hydraulically draw the water away to the collection tube. The water passes through the foam layer 706 where it is directed by the non-permeable layer 707 into the pipe 710 via the inlet 715. Water then flows through the pipe 710 and reaches pipe outlet 716 where the water is forced to exit. The water passes through the foam layer 708 where it is directed by the non-permeable layer 709 into the pipe 710 via the inlet 717. Water then flows through the pipe 710 to the stack foam filter outlet 718. These multiple layers can help to maximize surface area and allow additional reduction, higher flow rates and ease of manufacturing.

An alternative simultaneous water treatment system embodiment can also be described utilizing FIGS. 7 and 8A-8B. In this alternative embodiment foam layer 702 and non-permeable layer 703 are deleted. Water is capable of being poured directly into the influent side of the pipe 710. Water flows out of the pipe outlets 712, 714, 716 generally simultaneously onto a respective foam layer 704, 706, 708. Water then flows through those foam layers 704, 706, 708 and into the pipe inlets 713, 715, 717, thereby emptying generally simultaneously into a common reservoir in the effluent side of the pipe. In this configuration, instead of having water run through multiple foam layers, a single stage of treatment is being applied to multiple batches of water simultaneously, which can result in quicker treatment of the water.

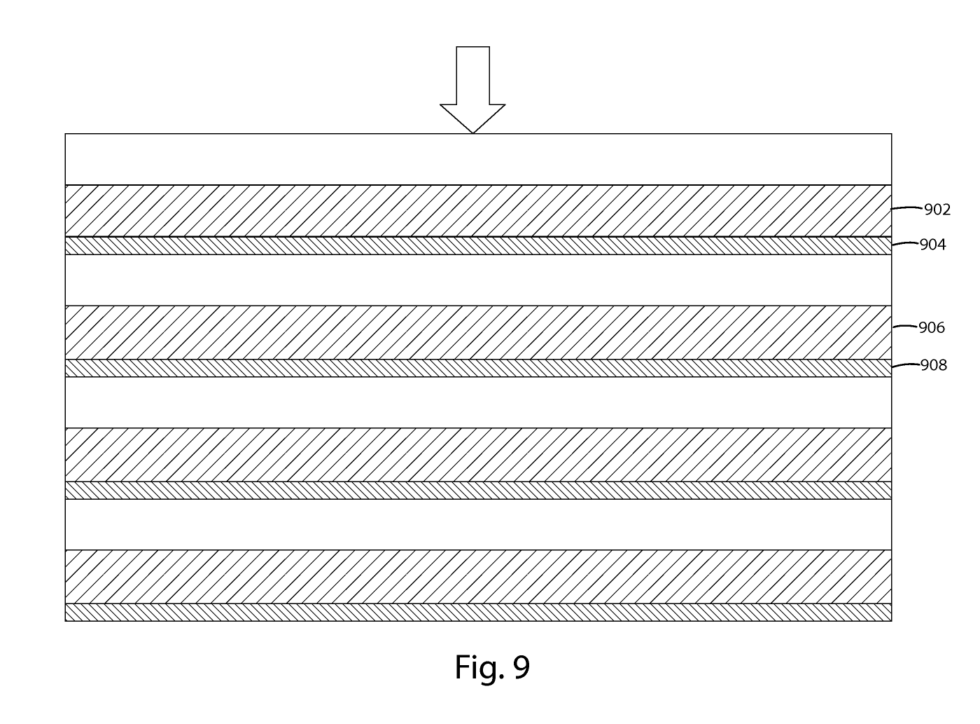

FIG. 9 illustrates an embodiment of a foam filter stack 900 that has successive water treatment stages. In the FIG. 9 embodiment, the top two foam layers 902, 904 become the inlet to the second two foam layers 906, 908 and this flow pattern repeats until the final stage. Each foam layer may include its own separate biological layer. Each stage may include other functional layers in addition to or instead of a biological layer in order to treat the water in a variety of different ways. Although the depicted embodiment includes four separate stages, each stage includes two foam layers. Alternative embodiments could include fewer or additional stages, and each stage could include fewer or additional foam layers. In addition, the characteristics of the foam, such as thickness and pore size, may vary from stage to stage and layer to layer. Areas of functional improvement may include carbon for filtering and for increased surface area, PH biased foam, foam that is food or mineral loaded specifically for different species that provide beneficial reduction. Minerals may include calcium, iron and other minerals that invoke specific biological and chemical interactions. It should be noted that these layers may be irrigated with a solution or even aerated to provide the optimal biological ecosystem. This ecosystem may require very different environments for each species thus each layer has an opportunity to provide combinations of these biological surrogates and functional filter layers for a tuned reduction system. Dehydrated organisms may be placed or sprayed on this media that have different functional performance and are used to assure the proper species, location and help to speed the growth process. This may also be in a liquid or gel form with a sealed package protecting the system. The package may include all the components that allows the proper growth of the biologicals.

FIG. 10 illustrates an embodiment of a foam filter stack 1000 in a cell configuration. The cell foam filter stack 1000 includes a plurality of cells 1001 stacked on top of one another, separated by a separator 1008. In the current embodiment, each cell includes four layers of foam 1002, 1003, 1004, 1005, a pair of end caps 1012, and a cell separator 1006. The cells are edge sealed with the end caps 1012 with a separate channel formed by the cell separator 1006. The separator 1006 allows flow to the central tube when the sides of the cells flatten The exterior foam 1002, 1004 provides an inlet path for the water. Once the water has passed through one of the exterior foam layers 1002, 1004 the water then flows through one of the interior foam layers 1003, 1005. After the interior foam layer, the water flows into the cell separator 1006 and into the inlet 1007 of the central outlet tube 1010. Although only two cells are depicted in the current embodiment, the number of cells can vary based on a variety of factors including the desired flow rate. The cells can be small or large in diameter. For example, the diameter of the cells can range from 6 inches to 12 inches.

Similar to the other foam filter stack configurations and foam cartridge configurations, the cell configuration fits within a water treatment system housing that has an inlet and an outlet. One difference between the cell configuration and the some of the other foam filter stack configurations is that the cell configuration is not sealed against the water treatment system housing wall so that water can surround the cells and enter from either side of the cell.

Although the figures provide a number of specific examples, it should be understood that various combinations of the features are possible. For example, essentially any of the embodiments could be modified to include additional foam layers for a variety of purposes, such as increased water treatment performance or to allow for easier cleaning and durability. Essentially any of the different foam layers described throughout the application can have different pore sizes. For example, in some embodiments, the pore size of the exterior foam may be coarser for extended life, while inner foam layers may have finer pores. Although the embodiments described above may utilize polyether sulphone for the foam layers, alternate foam materials may be substituted for polyether sulphone depending on the application. Depending on the construction of the foam filter cartridge or foam filter stack, many of the embodiments may be modified to treat other contaminants in water by utilizing functional layers within the cartridge. For example, by providing a layer beneath one of the foam layers that is impregnated with ion exchange resin the filter may be able to reduce hardness minerals or other health effect contaminants such as arsenic and/or nitrates.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to packages of any specific orientation(s).

Further, throughout this application reference is made to water treatment. It should be understood that the foam filters of the present invention may be utilized to treat substances other than water. Further, where reference is made to permeating, flowing through, or passing through a foam layer, it should be understood that this refers to the water passing through some or all of the pores in the element being referenced.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A filter comprising:
a reticulated foam filter element for filtering water, the foam filter element having a plurality of pores, wherein the foam filter element is usable for retaining a plurality of biological organisms at least one of adjacent the foam filter element and within the pores of the foam filter element;
a collection reservoir for collecting water that has been filtered by the foam filter element; and
a filter outlet in fluid communication with the collection reservoir for dispensing water from the filter,
wherein the foam filter element is densified to increase a number of strands per unit volume within the foam filter element.

2. The filter of claim 1 wherein the foam filter element includes nutrients positioned within one or more of the pores to provide sustenance for the biological organisms.

3. The filter of claim 1 wherein the foam filter element includes medical grade foam.

4. The filter of claim 3 wherein the medical grade foam is medical grade polyurethane foam.

5. The filter of claim 4 wherein a pore density of the foam filter element is greater than 70 pores per inch.

6. The filter of claim 5 wherein a thickness of the foam filter element is less than 1 inch, whereby the foam filter element does not become anaerobic during use.

7. The filter of claim 6 wherein the foam filter element is a radial flow foam filter element.

8. The filter of claim 7 wherein the foam filter element includes at least two radial flow foam filter elements, the at least two radial flow foam filter elements being connected to the filter outlet.

9. The filter of claim 1 wherein the radial flow foam filter element includes more than one foam layer, at least two of the foam layers having at least one of a different pore size, a different thickness, and a different foam type.

10. The filter of claim 1 including a functional layer for treating the water.

11. The filter of claim 1 wherein the foam filter element includes at least one of carbon, PH biased foam, food or mineral loaded foam, and dehydrated organisms.

12. The filter of claim 1 wherein the foam filter element is a single sheet of foam rolled into a spiral.

13. The filter of claim 6 wherein the foam filter element is a stack foam filter element and the collection reservoir is a pipe positioned adjacent the stack foam filter element.

14. The filter of claim 13 wherein the pipe defines at least one pipe inlet and the filter outlet,
wherein the stack foam filter element is fitted over the at least one pipe inlet, and
wherein the filter is adapted to route the water through the stack foam filter element to reach the at least one pipe inlet, into the pipe through the at least one pipe inlet, and out of the filter through the filter outlet.

15. The filter of claim 13 wherein the pipe defines a plurality of pipe inlets and a plurality of pipe outlets, the stack foam filter element including a plurality of stack foam layers, the stack foam layers spaced from one another, each stack foam layer fitted over at least one pipe inlet, at least one pipe outlet positioned between adjacent stack foam layers,
wherein the filter is adapted to route the water out of the pipe through each successive pipe outlet, through each successive stack foam layer and back into the pipe through each successive pipe inlet,
whereby the water travels through each stack foam layer before being dispensed from the filter.

16. The filter of claim 13 wherein the pipe defines a plurality of pipe inlets and a plurality of pipe outlets, each stack foam filter element including a plurality of stack foam layers, the stack foam layers spaced from one another, each stack foam layer fitted over at least one pipe inlet, at least one pipe outlet positioned between adjacent stack foam layers,
wherein the filter is adapted to route water out of the pipe through one of the pipe outlets, through one of the stack foam filter elements, back into the pipe through one of the pipe inlets, and out of the filter through the filter outlet,
whereby the water travels through only one stack foam layer before being dispensed from the filter.

17. The filter of claim 13 wherein the pipe defines at least one pipe inlet and the filter outlet,
wherein the stack foam filter element includes at least two stack foam layers, a first stack foam layer positioned on a first side of the at least one pipe inlet, a second stack foam layer positioned on a second, opposite side of the at least one pipe inlet, wherein the filter is adapted to route water into the filter through each stack foam layer, into the pipe through the at least one pipe inlet, and out of the filter through the filter outlet.

18. A filter comprising:
a reticulated foam filter element, the foam filter element being a radial flow foam filter element and including medical grade foam;
a restriction orifice to control a flow rate through the foam filter element;
the foam filter element having a plurality of pores and a pore density between 80 pores per square inch and 120 pores per square inch;
the foam filter element including nutrients to attract biological organisms; and
the foam filter element having a thickness less than 1 inch.

19. The filter of claim 18 wherein the foam filter element includes more than one layer of foam.

20. The filter of claim 18 wherein the restriction orifice restricts the flow rate to a maximum of between approximately 0.8 milliliters and 1.2 milliliters per minute per square centimeter of surface area of the foam filter element.
